(19) United States
(12) Patent Application Publication
(10) Pub. No.: US 2004/0113106 A1
(43) Pub. Date: Jun. 17, 2004

(54) Rain sensor capable of compensating for a change of infrared ray transmissivity of a windshield

(76) Inventor: Hyun Joong Pyun, Hwaseong-city (KR)

Correspondence Address: MORGAN, LEWIS & BOCKIUS, LLP., 3300 HILLVIEW AVENUE, PALO ALTO, CA, 94304, US

(21) Appl. No.: 10/639,209

(22) Filed: Aug. 11, 2003

(30) Foreign Application Priority Data
Dec. 13, 2002 (KR) 10-2002-0079569

(51) Int. Cl. G01N 15/06

(52) U.S. Cl. 250/573; 340/602

(57) ABSTRACT

A rain sensor for a vehicle including a light emitting device and a light receiving device that receives a portion of light reflected by a windshield is provided. The rain sensor comprises a variable resistor device and a control unit. The variable resistor device realizes a specific resistance that relates to an output value of the rain sensor. The control unit is configured to calculate infrared ray transmissivity of the windshield based on one or more parameters of the rain sensor, and to control the variable resistor device such that the resistance of the variable resistor device is determined according to the calculated transmissivity.

### FIELD OF THE INVENTION

The present invention relates to an optical sensor, and more particularly, to a rain sensor capable of automatically compensating for a change of infrared ray transmissivity of a windshield of a vehicle.

### BACKGROUND OF THE INVENTION

Generally, in a vehicle having a rain sensor, a windshield wiper system is automatically operated in response to output signals of the rain sensor.

A conventional optical rain sensor includes a light emitting diode and a photo diode. Light emitted by the light emitting diode is reflected by a windshield, and the reflected light strikes the photo diode. During the reflection, some portion of the light is scattered and emerges toward the outside when a moisture film or rain layer is formed on the outside surface of the windshield, and light is differently reflected according to the thickness of the water layer. The rain sensor detects whether a water layer is formed on the windshield using this characteristic of reflection.

According to the detection of a water layer on the windshield, an operation of the wiper is controlled, and an operating speed of the wiper is also controlled according to a thickness of the detected water layer.

There are two types of conventional rain sensors. The first type is used in a relatively narrow range of infrared ray transmissivity of a windshield, and it is operated by constant voltage. The second type is operated in a wide range of infrared ray transmissivity of a windshield, and it is operated by variable voltage.

The second type of rain sensor operates poorly when it is used with a dark-colored windshield, and it may operate abnormally because of external light. The first type of the rain sensor is therefore widely used for vehicles.

However, in the first type of rain sensor, if infrared ray transmissivity of a windshield deviates from a critical range, a resistor for an electric circuit of the rain sensor must be changed, which is a very difficult procedure. Furthermore, there is a limitation in compensating a change of the infrared ray transmissivity of the windshield by changing the resistor.

The information disclosed in this Background of the Invention section is only for enhancement of understanding of the background of the invention and should not be taken as an acknowledgement or any form of suggestion that this information forms the prior art that is already known to a person skilled in the art.

### SUMMARY OF THE INVENTION

In a preferred embodiment of the present invention, a rain sensor for a vehicle including a light emitting device and a light receiving device that receives a portion of light reflected by a windshield comprises a variable resistor device and a control unit. The variable resistor device realizes a specific resistance that relates to an output value of the rain sensor. The control unit is configured to calculate infrared ray transmissivity of the windshield based on one or more parameters of the rain sensor, and to control the variable resistor device such that the resistance of the variable resistor device is determined according to the calculated transmissivity.

It is preferable that the variable resistor device comprises a variable resistor, an actuator, and a controller. The actuator actuates the variable resistor to change the resistance of the variable resistor, and the controller controls the actuator according to a control signal input from the control unit. Preferably, the actuator is a step motor.

In another preferred embodiment of the present invention, a method is provided for compensating a change of infrared ray transmissivity of a windshield for a rain sensor including a light emitting device, a light receiving device that receives a portion of emitted light reflected by the windshield, and a variable resistor device, the method comprising: calculating infrared ray transmissivity of the windshield based on at least one parameter of the rain sensor; calculating a target resistance of the variable resistor device based on the calculated transmissivity; and controlling the variable resistor device such that a resistance of the variable resistor device becomes the calculated target resistance.

### BRIEF DESCRIPTION OF THE DRAWINGS

The accompanying drawings, which are incorporated in and constitute a part of the specification, illustrate an embodiment of the invention, and, together with the description, serve to explain the principles of the invention, where:

FIG. 1 is a schematic diagram showing a rain sensor according to a preferred embodiment of the present invention;

FIG. 2 shows a variable resistor and a control unit that are used in the rain sensor according to the preferred embodiment of the present invention; and

FIG. 3 is a flowchart of a method for compensating infrared ray transmissivity of a windshield for a rain sensor according to a preferred embodiment of the present invention.

### DETAILED DESCRIPTION OF THE PREFERRED EMBODIMENTS

Hereinafter, a preferred embodiment of the present invention will be described in detail with reference to the accompanying drawings.

A rain sensor 12 according to the preferred embodiment of the present invention includes a circuit board 18 that is mounted on an inner surface of a windshield 14 of a vehicle and is disposed within a housing 16. An optical device and an electrical device are mounted on the circuit board 18.

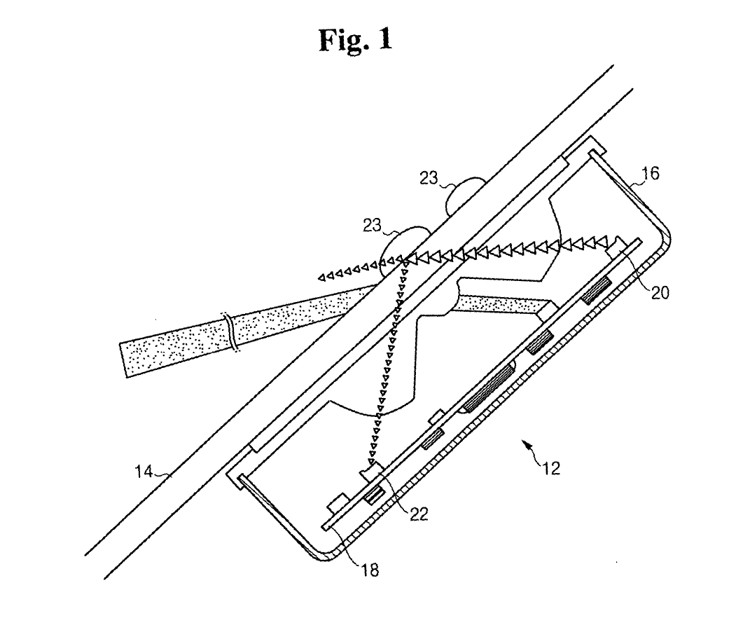

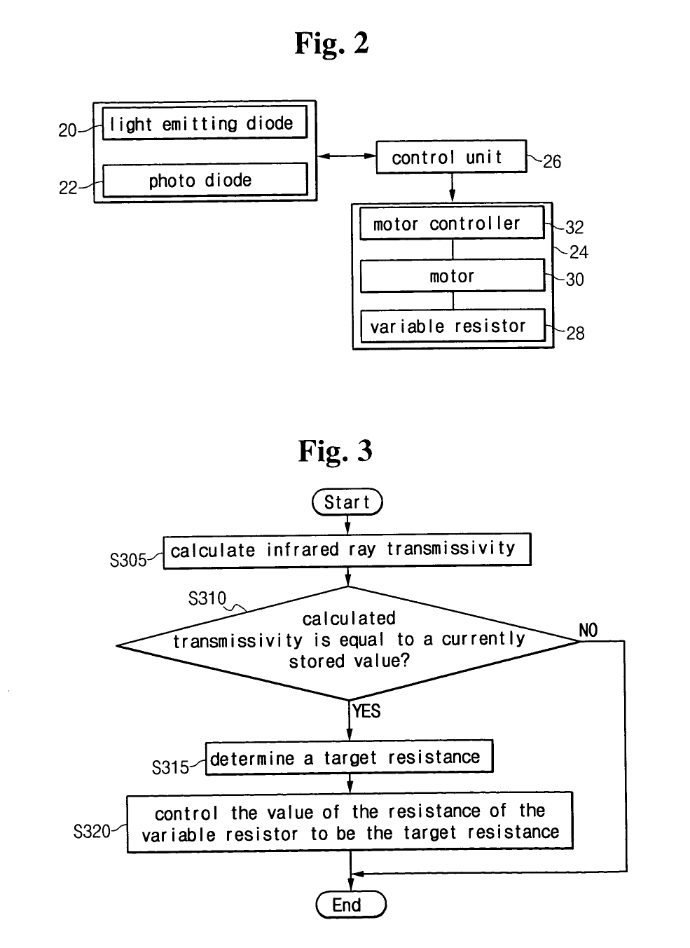

Overall structures of the rain sensor 12 as shown in FIG. 1 are well known in the art, so only portions related to the present invention will be explained.

A light source (for example, a light emitting diode) 20 is mounted on the circuit board 18, and it emits an infrared ray. Hereinafter, reference numeral 20 is referred to as the light emitting diode.

The infrared ray emitted from the light emitting diode 20 is reflected by the windshield 14, and the reflected infrared ray is transmitted to a photo diode 22 that is mounted on the circuit board 18.

At this time, when a water droplet 23 is formed on an outer surface of the windshield 14, a portion of the infrared ray emitted by the light emitting diode 20 is scattered and emerges toward the outside. Accordingly, an amount of light detected by the photo diode 22 decreases.

The electrical device that is mounted on the circuit board 18 includes a variable resistor device 24 that is used for generating an output value of the rain sensor 12 that indicates whether it rains or not. The resistance of the resistor device 24 must be changed according to a change of infrared ray transmissivity of the windshield 14. The rain sensor according to the preferred embodiment of the present invention adapts the variable resistor device 24 instead of changing a constant resistor according to a change of infrared ray transmissivity of the windshield 14.

The rain sensor 12 according to the preferred embodiment of the present invention further includes a control unit 26. The control unit 26 calculates infrared ray transmissivity of the windshield 14, and generates a signal to change resistance of the variable resistor device 24 according to the calculated transmissivity.

The variable resistor device 24 includes a variable resistor 28, a motor 30 for actuating the variable resistor 28 to realize a desired resistance, and a motor controller 32 for controlling the motor 30.

The variable resistor 28 is actuated by the motor 30, and resistance of the variable resistor 28 is thereby changed. The motor 30 can be realized by a step motor that can rotate bi-directionally.

The motor controller 32 receives a control signal indicating a target resistance from the control unit 26, and generates a corresponding signal to the motor 30.

The electric device is configured to generate an output signal corresponding to a change of resistance of the variable resistor 28. The electric circuit can be realized in various ways.

The control unit 26 preferably includes a microprocessor, a memory, and other necessary hardware and software components as will be understood by persons skilled in the art, to permit the control unit to execute the control function as described herein.

Referring to FIG. 3, an operation of the rain sensor 12 according to the preferred embodiment of the present invention will be explained hereinafter.

In step S305, the control unit 26 calculates infrared ray transmissivity of the windshield 14 on which the rain sensor 12 is mounted.

The transmissivity may be calculated based on a light emission amount of the light emitting diode 20, an amount of light received by the photo diode 22, a light injection angle, a light reflection angle, and the like.

After calculating the transmissivity, in step S310, the control unit 26 determines whether the calculated transmissivity is equal to a currently stored value. That is, the control unit 26 determines whether the transmissivity has been changed.

If the calculated transmissivity is equal to the currently stored value, the procedure ends. Meanwhile, if not so, in step S315, the control unit determines a target resistance according to the calculated transmissivity.

At the step S315, it is preferable that the target resistance is determined from a predetermined lookup table of resistance and transmissivity.

If a resistance of the resistor that relates to an output value of the rain sensor 12 is constant, an output value of the rain sensor may change according to the change of the infrared ray transmissivity of the windshield regardless of whether it rains or not, or an amount of rain. Therefore, if the resistance of the resistor of the rain sensor is constant, it is impossible to accurately detect an amount of water layer on the windshield. For this reason, the rain sensor 12 according to the preferred embodiment of the present invention changes resistance of the resistor corresponding to the change of the infrared ray transmissivity of the windshield.

If the electric circuit of the rain sensor 12 is configured such that a value of the output signal (for example, a current signal) of the rain sensor 12 increases as an amount of rain increases, that is an amount of receiving light of the photo diode 22 decreases, a light receiving amount of the photo diode 22 increases with the increase of the transmissivity of the windshield 14, and accordingly, the output value of the rain sensor 12 decreases. Therefore, in this case, if an output value of the rain sensor 12 is reversely proportional to the value of the resistance of the variable resistor device 24, the decrease of the output value of the rain sensor 12 caused by the increase of the transmissivity of the windshield 14 can be calibrated by decreasing the value of the resistance of the variable resistor device 24.

The lookup table of the value of the resistance of the variable resistor device 24 to the transmissivity of the windshield 14 can be determined in the above-stated way.

After determining the target resistance, in step S320, the control unit 26 outputs a corresponding control signal for controlling the value of the resistance of the variable resistor 28 to be the target resistance to the motor controller 32. The motor controller 32 controls the motor 30 such that the resistance of the variable resistor 28 becomes the target resistance.

Therefore, even when the transmissivity of the windshield 14 has been changed, the output value of the rain sensor 12 can be prevented from being distorted by changing the resistance of the variable resistor device 24.

Because the rain sensor according to the preferred embodiment of the present invention is provided with the variable resistor device whose resistance can be changed according to the change of transmissivity of the windshield, the distortion of the output value of the rain sensor can be compensated without changing the resistor.

Although preferred embodiments of the present invention have been described in detail hereinabove, it should be clearly understood that many variations and/or modifications of the basic inventive concepts herein taught which may appear to those skilled in the present art will still fall within the spirit and scope of the present invention, as defined in the appended claims.

Throughout this specification and the claims which follow, unless explicitly described to the contrary, the word “comprise” or variations such as “comprises” or “comprising” will be understood to imply the inclusion of stated elements but not the exclusion of any other elements.

What is claimed is:

1. A rain sensor for a vehicle including a light emitting device and a light receiving device that receives a portion of light reflected by a windshield, comprising:
a variable resistor device for realizing a specific resistance that relates to an output value of the rain sensor; and
a control unit configured to calculate infrared ray transmissivity of the windshield based on one or more parameters of the rain sensor, and to control the variable resistor device such that the resistance of the variable resistor device is determined according to the calculated transmissivity.

2. The rain sensor of claim 1, wherein the variable resistor device comprises:
a variable resistor;
an actuator for actuating the variable resistor to change resistance of the variable resistor; and
a controller for controlling the actuator according to a control signal input from the control unit.

3. The rain sensor of claim 2, wherein the actuator is a step motor.

4. A method for compensating a change of infrared ray transmissivity of a windshield for a rain sensor including a light emitting device, a light receiving device that receives a portion of emitted light reflected by the windshield, and a variable resistor device, the method comprising:
calculating infrared ray transmissivity of the windshield based on at least one parameter of the rain sensor;
calculating a target resistance of the variable resistor device based on the calculated transmissivity; and
controlling the variable resistor device such that a resistance of the variable resistor device becomes the calculated target resistance.
